(19) United States
(12) Patent Application Publication
(10) Pub. No.: US 2025/0124019 A1
(43) Pub. Date: Apr. 17, 2025

(54) EVENT HYDRATION AND VALIDATION FOR EFFICIENT REPORT GENERATION

(71) Applicant: Maplebear Inc., San Francisco, CA (US)

(72) Inventors: Bruno Caminada, Snohomish, WA (US); Peter Lambe, Brooklyn, NY (US)

(21) Appl. No.: 18/488,734

(22) Filed: Oct. 17, 2023

(51) Int. Cl. G06F 16/23; G06F 9/54

(52) U.S. Cl. CPC G06F 16/2379; G06F 9/542

(57) ABSTRACT

A system performs incremental updates to an event data store based on hydration and stateful validation of events to allow efficient generation of reports based on event data. The system stores data describing events received in a raw event data store. An event represents user interactions associated with a content item. Each event is classified as a thin event, or a thick event based on the type of user interaction associated with the event. The system monitors changes to the raw event data store, for example, using a listener process. The system stores event data in a hydrated event data store that includes records, each record storing information describing thin events associated with a thick event along with additional attributes describing each thin event.

### BACKGROUND

One or more aspects described herein relate generally to data analytics based on event data generated by an online system and more specifically to hydration based incremental processing of event data for performing data analytics.

An online system receives information describing events, for example, events representing user interactions associated with content items. Often, analytical reports are generated based on the user interaction information. The reports typically combine additional information with the user interactions, for example, a report may combine user profile information with event data describing interaction of a user with a content item. Typically, such reports are generated using database queries, for example, database queries specified using structured query language (SQL). These database queries join tables representing the event data with other tables such as tables storing user data. Such joins are typically computationally intensive operations if a large number of events are processed. Furthermore, such reports may be generated periodically, for example, on a daily or hourly basis. Such processing typically requires large amount of computational resources.

### SUMMARY

A system according to one or more embodiments, performs incremental updates to an event data store by hydrating events as events are received. The system stores data describing events received in a raw event data store, for example, a key-value store. Each event may be classified as a thin event, or a thick event. A thick event causes selection of a content item from multiple content items for presentation to a user. A thin event may represent user interactions associated with the content item. The system monitors changes to the raw event data store, for example, using a listener process. If the system receives a thin event associated with a thick event, the system performs hydration of the thin event by performing following steps. The system receives an indication of a new thin event associated with a thick event. If system determines that the thick event associated with the thin event was previously added to the raw event data store, the system determines that the thin event is ready for hydration. The system identifies additional attributes associated with the thin event, for example, user profile attributes of the user that performed the user interactions. The system stores attributes describing the thin event including attributes received with the thin event and additional attributes identified by the system to a record in a hydrated event data store.

The system uses the data stored in the hydrated event data store for downstream processing. For example, the system generates reports based on records stored in the hydrated event data store. As another example, the system provides data stored in the hydrated event data store as training data for training a machine learning model.

According to one or more embodiments, the system performs validation of events. The system compares time stamps of thin events. If two thin events have a timestamp that is within a threshold value of each other, the system invalidates one of the thin events.

### BRIEF DESCRIPTION OF THE DRAWINGS

FIG. 1 illustrates an example system environment for an online system configured to perform incremental processing of event data based on hydration, in accordance with one or more embodiments.

FIG. 2 illustrates an example system architecture of the event processing module, in accordance with one or more embodiments.

FIG. 3 is a flowchart illustrating the process for hydrating events for generating reports, in accordance with one or more embodiments.

FIG. 4 is a flowchart illustrating the process for sessionization of events, in accordance with one or more embodiments.

### DETAILED DESCRIPTION

An online system presents content items to users and monitors user interactions associated with the content items. The online system receives events representing user interactions associated with the content items. For example, an event may represent a user clicking on a content item to interact with the content item. An event may represent the user viewing the content item responsive to being presented with the content item. The system groups events that are related to each other. The system further retrieves additional information associated with the events that are grouped, for example, information describing the user that performed the interaction, information describing the client device used to perform the interaction, and so on.

The process of assimilating information associated with an event in a record is also referred to as hydration of the event. The system performs incremental hydration of events as each event is received by the system. The records storing the information assimilated over a period of time may be analyzed for gaining insights over the content items. For example, the system generates reports based on data analytics associated with content items and related events.

The online system may store information describing the events in various data stores, for example, database tables of a relational database or in a key-value store. The system may store auxiliary information such as user profile information also in database tables. Such systems perform joins of information stored in the data stores, for example, join operations that combine information from multiple database tables. Such join operations are performed on a periodic basis as a batch process, for example, every hour to generate an updated report or to provide the updated data to a downstream process or system. Such join operations process information collected over a recent time window, for example, a look back window over the past 24 hours, past several days, or past month. A large number of events may be received over a period of 48 hours resulting in a large number of entries in the database tables. As a result, generating reports periodically by joining information in several tables can be a highly computationally intensive operation. Furthermore, as updated reports are generated periodically, the same processing may be repeated multiple times. For example, two time-windows of 48 hours that are computed an hour apart include significant overlap of the data processed. As a result, several events are processed repeatedly as the reports are regenerated periodically. This results in wasted computational effort. The techniques disclosed were experimentally determined to provide performance improvements up to 50% or more compared to conventional techniques based on join of tables. Furthermore, the techniques provide improvement in latency in terms of the time when the results are provided compared to the time that a request is received. Improvements in latency of a factor of 2-3 can be obtained using the techniques disclosed compared to conventional techniques. Accordingly, the techniques disclosed herein provide performance improvement compared to existing techniques.

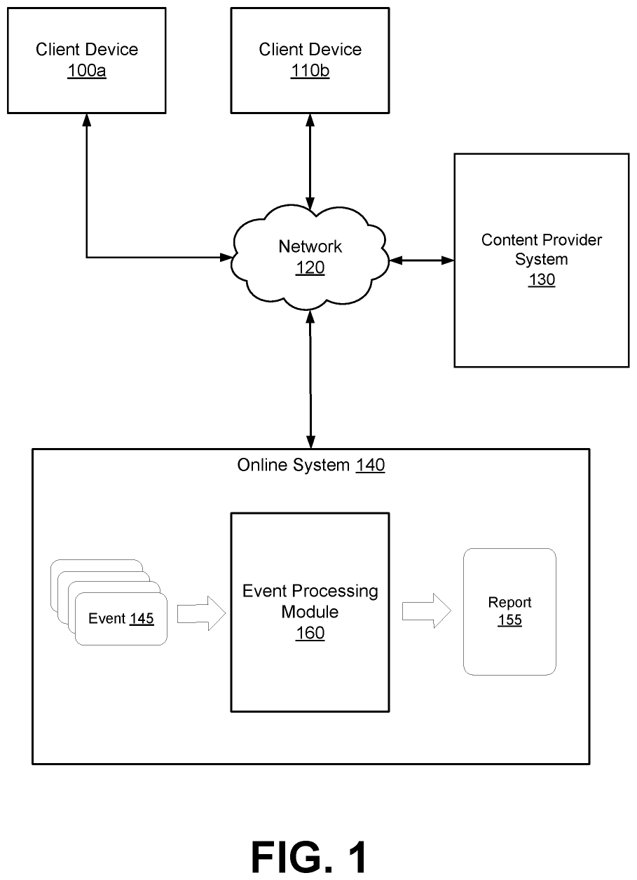

FIG. 1 illustrates an example system environment for an online system configured to perform incremental processing of event data based on hydration, in accordance with one or more embodiments. The system environment illustrated in FIG. 1 includes one or more client devices 100a, 100b, a content provider system 130, a network 120, and an online system 140. Alternative embodiments may include more, fewer, or different components from those illustrated in FIG. 1, and the functionality of each component may be divided between the components differently from the description below. For example, there may be multiple content provider systems that provide content items to the online system. Additionally, each component may perform their respective functionalities in response to a request from a human, or automatically without human intervention.

The content provider system 130 is coupled to the network 120 for communicating with the online system 140. The content provider system 130 maintains a content store which stores content items. Examples of content represented by an object include images, videos, webpages, and so on. The content item may describe a product or service offered by the content provider system 130 or an enterprise associated with the content provider system 130. For example, the content item may be an image of a product, a web page that describes the product, or a video showing use of the product. According to one or more embodiments, the content items provided by the content provider system 130 are sponsored content items for which the content provider system 130 provides remuneration to the online system 140 for distributing the content items which can be defined as a cost for each instance of distribution of a content item. An example of a sponsored content item is an advertisement. In other embodiments, the content provider system 130 provides content or other information for presentation directly to the client device 110.

In some instances, a user performs user interactions associated with a content item. The user interaction may represent the user accessing the content item, for example, by clicking on the content item. The user interaction may represent viewing the content item by the user performed as a result of presenting the content item via a user interface to the user. The operation of presenting the content item to the user for viewing is also referred to as an impression of the content item. The user may perform a user interaction responsive to accessing the content item. For example, if the content item describes a web site associated with the content provider system, a user may register with the website after viewing the content item. In other embodiments, a content item may describe an item, for example, a product or a service provided by the content provider system and the user action comprises completing a transaction, for example, a purchase of the item. The user may purchase the item described in the content item or a different item. As another example, the content describes a website, and the user simply accesses the website. As another example, the content item describes an event, and the user action comprises sending an RSVP message for the event or purchasing a ticket for the event or checking in to the location of the event.

The online system 140 receives events 145 that represent operations associated with content items. An event represents a type of operation associated with a content item. An event may be a thick event or a thin event. The system classifies the event as a thick event or a thin event based on the type of operation represented by the event. According to one or more embodiments, a thick event represents an operation that results in selection of content items for being presented to a user. The content item is selected from a plurality of candidate content items identified for potentially presenting to users. According to one or more embodiments, a thick event represents an auction event in which multiple content provider systems participate. Each content provider submits a bid for the auction process and the system selects a content item from a plurality of content items based on the bids provided by the content providers. Each thin event received identifies a corresponding thick event that caused the content item to be provided to the user. A thick event stores more information compared to a thin event. The thick event stores information identifying the content item, information identifying the user, and any other relevant contextual information describing the reason the content item was selected for being provided to the user. For example, the user may be provided with the content item because the user was visiting a particular web page, or the user performed a search operation specifying certain keywords, and so on.

A thin event may represent a user interaction associated with a content item. For example, a thin event may represent a user clicking on the content item to access more information related to the content item. As another example, if the content item represents a video and the user is presented with a link to the video via an image or a thumbnail, the thin event may represent the user clicking on the image or thumbnail to view the video.

The event processing module 160 performs various types of processing of the events. For example, the event processing module 160 collects related events and stores information describing the related events in a record for easy access and processing. The event processing module 160 processes the events to perform actions such as generating reports based on analytical information obtained from the events. For example, if several users access a content item over a period of time, the event processing module 160 may generate reports that describe distribution of the events, such as the number of events per location or number of events per user profile attribute such as gender, ethnicity, ranges of ages, and so on. The event processing module 160 may provide information describing the events as training data sets or features to machine learning based models such as neural networks for making certain predictions. For example, a machine learning model trained using the event data may predict a score representing a likelihood of a particular user interacting with a content item if presented with the content item.

The client devices 110a, 100b are one or more computing devices capable of receiving user input as well as transmitting and/or receiving data via the network 120. According to one or more embodiments, a client device 110 is a conventional computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. According to one or more embodiments, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™. The client device 110 can receive content items from the online system 140 for display by the client device 110. In the above embodiments, the client device 110 may present content items via a browser application or an API running on the native operating system of the client device 110.

The client devices 100a, 100b, the content provider system 130, and the online system 140 can communicate with each other via the network 120. The network 120 is a collection of computing devices that communicate via wired or wireless connections. The network 120 may include one or more local area networks (LANs) or one or more wide area networks (WANs). The network 120, as referred to herein, is an inclusive term that may refer to any or all of standard layers used to describe a physical or virtual network, such as the physical layer, the data link layer, the network layer, the transport layer, the session layer, the presentation layer, and the application layer. The network 120 may include physical media for communicating data from one computing device to another computing device, such as MPLS lines, fiber optic cables, cellular connections (e.g., 3G, 4G, or 5G spectra), or satellites. The network 120 also may use networking protocols, such as TCP/IP, HTTP, SSH, SMS, or FTP, to transmit data between computing devices. In one or more embodiments, the network 120 may include Bluetooth or near-field communication (NFC) technologies or protocols for local communications between computing devices. The network 120 may transmit encrypted or unencrypted data.

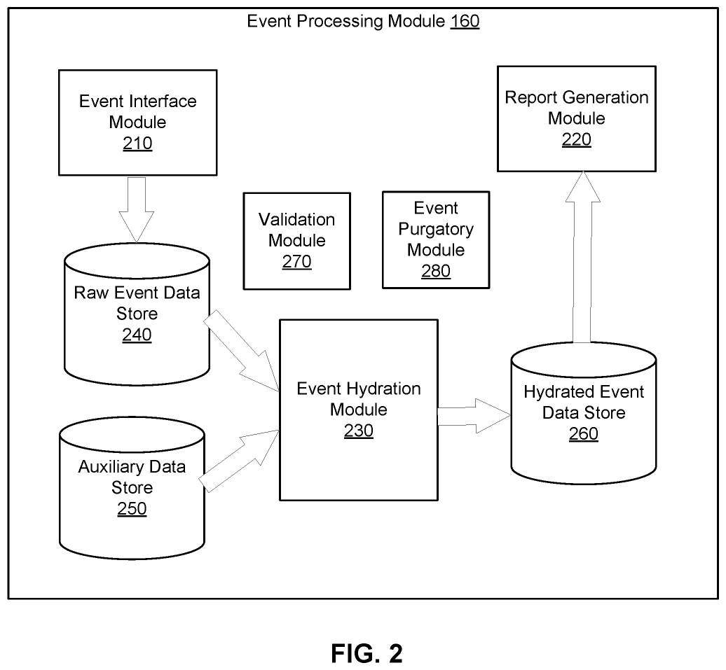

FIG. 2 illustrates an example system architecture of the event processing module, in accordance with one or more embodiments. The system architecture illustrated in FIG. 2 includes an event interface module 210, a report generation module 220, an event hydration module 230, a validation module 270, an event purgatory module 280, a raw event data store 240, an auxiliary data store 250, and a hydrated event data store 260. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The event interface module 210 receives event information from client devices and provides them to other components or modules within the event processing module. According to one or more embodiments, the event data is received as stream data.

The events received by the event interface module 210 are stored in the raw event data store 240. According to one or more embodiments, the raw event data store 240 is a key-value store that maps data as values stored in association with a key. The key-value store uses an identifier of a thick event as a key. The attributes of the thick event are stored as values mapped to the key identifying the thick event. The data of the thin events associated with a thick event includes the identifier of the thick event that is used as the key in the key-value store. Accordingly, the thin events associated with a thick event are also stored using the key for the thick event. The key based on the thick event may also be referred to as an auction identifier if the thick event is an auction event that selects the content item for presentation to the user from a set of candidate content items.

The validation module 270 performs validation of the event data. The validation module performs two types of validations static validations and stateful validations. The validation module 270 performs static validation of event data by ensuring that each attribute value is valid and satisfies certain predefined constraints. For example, if an attribute value represents a date, the validation module 270 checks if the data value is formatted properly. Similarly, if an attribute represents a country code, the validation module 270 may perform static validation to check if the attribute represents a valid country code. If an attribute value is an address, the validation module 270 may check if the address is formatted correctly. Stateful validations require context from other mutable tables from some period of time for performing the validation.

According to one or more embodiments, the validation module 270 performs incremental sessionization to determine whether an event is valid or invalid. Sessionization refers to determining sessions associated with events. The validation module 270 identifies a set of events associated with a thick event and determines whether pairs of events belong to the same session. The system may compare the time that an event was created to determine whether two events belong to the same session. If the time that a thin event was created cannot be determined accurately, the system uses the time of the corresponding thick event for comparing two thin events. If an event was created close to another thin event, i.e., within a threshold time (e.g., 60 seconds) of the other thin event, the validation module 270 invalidates the second event, thereby ignoring the data of the second thin event. An invalid event is treated as if the event was never received and is skipped from any computations based on the event data, for example, data analytics report computations. If an event arrives more than a threshold time after the other thin event, the validation module 270 treats the second event as a valid thin event. The validation module 270 groups events that arrive close to each other in time as a session. For example, the validation module 270 may treat the events as if they were created during a session of the length of the threshold time value (e.g., 60 seconds). Accordingly, if a user clicks multiple times on a content item within a session, the validation module 270 treats the multiple clicks as a single click. The validation module 270 uses a moving time window of a fixed length, for example, 60 seconds to perform validation of events. Note that there are challenges in validation since the system is distributed and events may arrive out of order. The system disclosed is resilient to events arriving out of order, for example, an event with an earlier timestamp is received later compared to another event. Since the validation is performed based on the earliest event received, if an out of order event is received that has a timestamp before the earliest event, the system needs to recompute the validation status of all events for a partition. The system uses an incremental logic that drastically reduces the computational time by guaranteeing that the only data that is recomputed is precisely the data that could be changed because of the out-of-order event.

According to one or more embodiments, the validation module 270 invalidates events based on a user identifier and a product identifier that identifies the product described in the content item. Accordingly, if two thin events created within the threshold time interval have matching user identifier and product identifier, one of the events (e.g., the second event) is invalidated. This ensures that if the same user triggers two thin events within a threshold time interval based on a content item for a product, the two thin events are treated as a single thin event. According to one or more embodiments, the validation module 270 invalidates events based on a user identifier and a content item identifier that identifies the content item.

Conventional techniques that perform validation as a batch process result in processing a large amount of data since for certain data it is difficult to track whether the data is newly received or was previously received and processed earlier. As a result, the same data may get processed multiple times, leading to waste of computational resources and results in storing data that is not needed, thereby wasting storage resources. The validation module 270 performs incremental validation that processes only new events received and has significantly lower computational cost and storage cost since the process avoids processing the same event data multiple times, thereby improving the computational efficiency. The validation module 270 also reduces the amount of event data that is stored, thereby improving the storage efficiency.

The auxiliary data store 250 stores information representing attributes that are associated with a set of related events. For example, the auxiliary data store 250 may store information describing the user that performs a user interaction with a content item. The auxiliary data store 250 may store information describing the content item. The auxiliary data store 250 may store information describing the content provider that provided the content item. The auxiliary data store 250 may be referred to as dimension tables that store various types of data associated with the event.

The event hydration module 230 performs hydration of events, for example, by combining the attributes of a thin event with attributes of the corresponding thick event and storing the combined information in a record of the hydrated event data store 260. According to one or more embodiments, the event hydration module 230 includes a listener that monitors changes to the raw event data store 240. As a result, the event hydration module 230 gets a notification whenever a new event is added to the raw event data store 240. The event hydration module 230 performs hydration of event data after one or more events are received. The event hydration module 230 may perform hydration of event data after each event is received, or after a fixed number of events are received.

According to one or more embodiments, the listener of the event hydration module 230 is implemented as a change data feed stream that reports all changes made to the raw event data store 240. The event hydration module 230 parses the change data feed stream received and identifies the events that were recently added to the raw event data store 240 and processes them as necessary. If a thin event is received for which the associated thick event has not yet been received, the event hydration module 230 waits for the thick event to arrive and accordingly postpones the processing of the thin event. If a thin event is received for which the associated thick event has already been received, the event hydration module 230 can proceed with hydration of the thin event.

The various systems within the system environment shown in FIG. 1 form a distributed system. Accordingly, events are not guaranteed to arrive in the order in which the events were created. If an event arrives late, the event may not get joined to the record of a corresponding thick event in the hydrated event data store 260. The event purgatory module 280 manages such events that failed to get combined with the related set of events. If an event fails to get hydrated by the event hydration module 230, the event purgatory module 280 stores the event in a data store, for example, a purgatory database table. The event purgatory module 280 periodically attempts to rehydrate the events that were stored in the purgatory database table. If an event fails to hydrate during the attempts made within a time window, for example, a day, the event purgatory module 280 deletes the event or marks the event such that it is not processed any more.

According to one or more embodiment, the event purgatory module 280 performs hydration of thick events with eventually consistent dimensional data from external database sources. In such a scenario, the thick event is sent to temporary purgatory and attempts rehydration for up to 24 h before being sent to permanent purgatory; any thin events waiting for the pre-hydrated thick event after this threshold are also sent to purgatory and are not retried.

The report generation module 220 generates reports based on the records of the hydrated event data store 260. The reports may be analytical reports that provide insights into the event data gathered over time. The report generation module 220 may generate reports periodically or update reports periodically and provide them to a user. In one or more embodiments, the records stored in the hydrated event data store 260 may be used for other purposes, for example, to generate training dataset for training machine learning models.

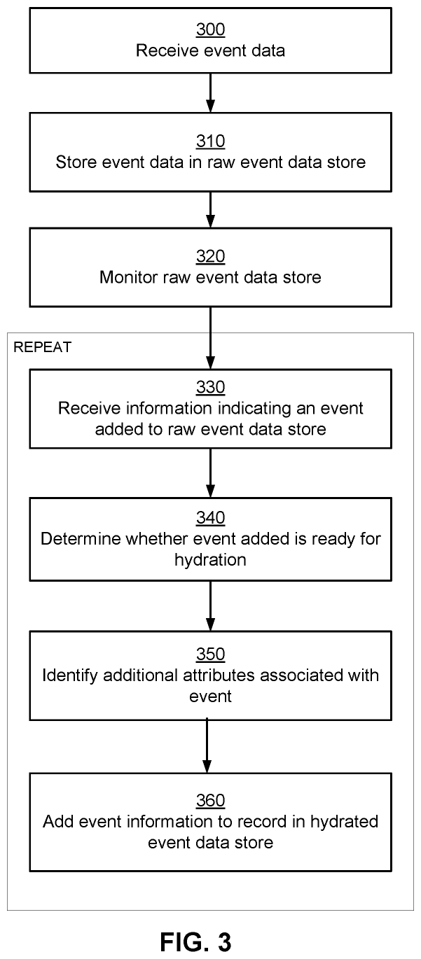

FIG. 3 is a flowchart illustrating the process for hydrating events for generating reports, in accordance with one or more embodiments. Alternative embodiments may include more, fewer, or different steps from those illustrated in FIG. 3, and the steps may be performed in a different order from that illustrated in FIG. 3. These steps may be performed by a system (e.g., the online system 140). According to one or more embodiments the steps are performed by the event hydration module 230.

The system receives 300 event data, for example, thin events or thick events associated with a content item presented to a user. The system stores the event data in a raw event data store 240. If the event received is a thin event associated with a thick event, the system determines whether the thick event is already stored in the raw event data store 240. If the thick event is available in the raw event data store 240 the system stores 310 the thin event in the raw event data store 240. The received thin event identifies the thick event using the thick event id. The system maps the thin event to the key for the thick event. The system monitors 320 the raw event data store 240, for example, using a listener or a change data feed stream associated with the raw event data store 240.

The system repeats the steps 330, 340, 350, 350 for changes monitored in the raw event data store 240. The system receives 330 information indicating addition of a new thin event to the raw event data store 240. The system determines 340 whether the new thin event is ready for hydration. The new thin event is determined to be ready for hydration if the thick event associated with the new thin event was previously received and stored in the raw event data store 240. If the thick event associated with the thin event is not available in the raw event data store 240, the system determines that the thin event is not ready for hydration. The system identifies 350 additional attributes associated with the event from the auxiliary data store 250. These attributes may describe the user performing the user interaction represented by the new thin event, information describing the content item associated with the thin event, information describing a campaign associated with the distribution of the content item associated with the thin event, and so on. The system adds 360 the event information to a record in the hydrated event data store 260. The event information includes the attributes of received with the new thin event and the additional attributes identified 350 for the new thin event.

According to one or more embodiments, the step 350 occurs before steps 340. The system may continuously monitor the hydration key-value store for changes to determine if the event is ready for hydration. The key value store uses the thick event identifier as a key and the corresponding attributes as a value. The system merges attributes and the identifier of a thin event within the values saved in this key-value store. The listener determines when new identifiers and attributes were merged with the original values and extracts the full hydrated record from this key value store. A single row in this key-value store may hydrate multiple thin events at once, which results in significant efficiency gains of the system.

The system accordingly hydrates the new events by adding their information to the hydrated event data store 260. As a result, information of various thin events corresponding to a thick event as well as associated auxiliary information is stored in association with the thick event in the hydrated event data store 260. This allows a system to efficiently process the information, for example, for generating analytical reports or for providing the data as training dataset for training machine learning models.

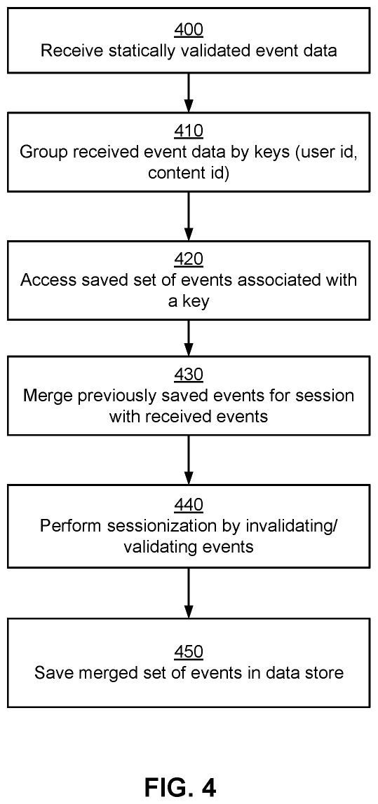

FIG. 4 is a flowchart illustrating the process for sessionization of events, in accordance with one or more embodiments. Alternative embodiments may include more, fewer, or different steps from those illustrated in FIG. 3, and the steps may be performed in a different order from that illustrated in FIG. 3. These steps may be performed by a system (e.g., the online system 140). According to one or more embodiments the steps are performed by the validation module 270.

The system receives 400 or accesses statically validated data. The system groups 410 event data by a key comprising a pair of a user identifier and a product identifier or a pair of user identifier and a content identifier. The system accesses 420 a previously saved set of events having mapped to a particular key. The system merges the saved set of events mapped to the key with newly received events mapped to the key. The system performs sessionization of the set of events by sorting the set of events by their associated timestamp (e.g., time of creation) and invalidating events that are within a threshold time interval of a previous event and treating events that exceed a threshold time interval of the closest previous event as valid events. The system saves the merged set of events in a data store. According to one or more embodiments, the data store used for storing the events is an in-memory distributed key-value data store.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

1. A method, performed at a computer system comprising a processor and a computer-readable medium, the method comprising:
storing, in a raw event data store, data describing events received, each event classified as a thin event or a thick event, wherein a thick event represents an operation that results in selection of a content item for presentation to a user, and a thin event represents a user interaction with the selected content item after the selected content item has been presented to the user;
monitoring changes to the raw event data store;
storing hydrated event data in a hydrated event data store, hydrated event data comprising records, each record storing information describing thin events associated with a thick event, storing hydrated event data in hydrated event data store comprising by repeatedly:
receiving an indication of addition of a new thin event to the raw event data store, the new thin event comprising event attributes; and
responsive to determining that the new thin event is associated with a thick event previously added to the raw event data store:
identifying one or more additional attributes associated with the thin event, and
storing event attributes of the new thin event and the one or more additional attributes in a record associated with the thick event in the hydrated event data store; and
generating a report based on records stored in the hydrated event data store.

2. The method of claim 1, wherein the new thin event is a first thin event, the method further comprising:
receiving an indication of addition of a second thin event to the raw event data store;
comparing a time of creation of the second thin event with a time of creation of the first thin event; and
responsive to determining that the time of creation of the second thin event is within a threshold value of the time of creation of the first thin event, determining the second thin event as invalid, wherein an invalid event is not added to the record associated with the thick event.

3. The method of claim 2, further comprising:
receiving an indication of addition of a third thin event to the raw event data store;
comparing a time of creation of the third thin event with a time of creation of the first thin event; and
responsive to determining that the time of creation of the second thin event exceeds the threshold value from the time of creation of the first thin event, determining the second thin event as valid, wherein a valid event is added to the record associated with the thick event.

4. The method of claim 1, further comprising:
storing additional attributes associated with an event in one or more database tables, wherein identifying one or more additional attributes associated with the thin event comprises joining the event attributes with the one or more database tables storing additional attributes.

5. The method of claim 1, wherein the raw event data store is a key-value store, wherein each event is stored using a key associated with a thick event, wherein monitoring the raw event data store comprises listening to changes to the key-value store.

6. The method of claim 1, wherein a thick event causes selection of a content item from a plurality of content items.

7. The method of claim 6, wherein a thin event represents a user interaction with the content item.

8. The method of claim 6, wherein a thin event represents presenting the content item to a user via a webpage.

9. A non-transitory computer readable storage medium storing instructions that when executed by one or more computer processors cause the one or more computer processors to perform steps comprising:
storing, in a raw event data store, data describing events received, each event classified as a thin event or a thick event, wherein a thick event represents an operation that results in selection of a content item for presentation to a user, and a thin event represents a user interaction with the selected content item after the selected content item has been presented to the user;
monitoring changes to the raw event data store;
storing hydrated event data in a hydrated event data store, hydrated event data comprising records, each record storing information describing thin events associated with a thick event, storing hydrated event data in hydrated event data store comprising by repeatedly:
receiving an indication of addition of a new thin event to the raw event data store, the new thin event comprising event attributes; and
responsive to determining that the new thin event is associated with a thick event previously added to the raw event data store:
identifying one or more additional attributes associated with the thin event, and
storing event attributes of the new thin event and the one or more additional attributes in a record associated with the thick event in the hydrated event data store; and
generating a report based on records stored in the hydrated event data store.

10. The non-transitory computer readable storage medium of claim 9, wherein the new thin event is a first thin event, wherein the instructions when executed by the one or more computer processors, cause the one or more computer processors to further perform steps comprising:
receiving an indication of addition of a second thin event to the raw event data store;
comparing a time of creation of the second thin event with a time of creation of the first thin event; and
responsive to determining that the time of creation of the second thin event is within a threshold value of the time of creation of the first thin event, determining the second thin event as invalid, wherein an invalid event is not added to the record associated with the thick event.

11. The non-transitory computer readable storage medium of claim 10, wherein the instructions when executed by the one or more computer processors, cause the one or more computer processors to further perform steps comprising:
receiving an indication of addition of a third thin event to the raw event data store;
comparing a time of creation of the third thin event with a time of creation of the first thin event; and
responsive to determining that the time of creation of the second thin event exceeds the threshold value from the time of creation of the first thin event, determining the second thin event as valid, wherein a valid event is added to the record associated with the thick event.

12. The non-transitory computer readable storage medium of claim 9, wherein the instructions when executed by the one or more computer processors, cause the one or more computer processors to further perform steps comprising:
storing additional attributes associated with an event in one or more database tables, wherein identifying one or more additional attributes associated with the thin event comprises joining the event attributes with the one or more database tables storing additional attributes.

13. The non-transitory computer readable storage medium of claim 9, wherein the raw event data store is a key-value store, wherein each event is stored using a key associated with a thick event, wherein monitoring the raw event data store comprises listening to changes to the key-value store.

14. The non-transitory computer readable storage medium of claim 9, wherein a thick event causes selection of a content item from a plurality of content items.

15. A computer system comprising:
one or more computer processors; and
a non-transitory computer readable storage medium storing instructions that when executed by the one or more computer processors cause the one or more computer processors to perform steps comprising:
storing, in a raw event data store, data describing events received, each event classified as a thin event or a thick event, wherein a thick event represents an operation that results in selection of a content item for presentation to a user, and a thin event represents a user interaction with the selected content item after the selected content item has been presented to the user;
monitoring changes to the raw event data store;
storing hydrated event data in a hydrated event data store, hydrated event data comprising records, each record storing information describing thin events associated with a thick event, storing hydrated event data in hydrated event data store comprising by repeatedly:
receiving an indication of addition of a new thin event to the raw event data store, the new thin event comprising event attributes; and
responsive to determining that the new thin event is associated with a thick event previously added to the raw event data store:
identifying one or more additional attributes associated with the thin event, and
storing event attributes of the new thin event and the one or more additional attributes in a record associated with the thick event in the hydrated event data store; and
generating a report based on records stored in the hydrated event data store.

16. The computer system of claim 15, wherein the new thin event is a first thin event, wherein the instructions when executed by the one or more computer processors, cause the one or more computer processors to further perform steps comprising:
receiving an indication of addition of a second thin event to the raw event data store;
comparing a time of creation of the second thin event with a time of creation of the first thin event; and
responsive to determining that the time of creation of the second thin event is within a threshold value of the time of creation of the first thin event, determining the second thin event as invalid, wherein an invalid event is not added to the record associated with the thick event.

17. The computer system of claim 16, wherein the instructions when executed by the one or more computer processors, cause the one or more computer processors to further perform steps comprising:
receiving an indication of addition of a third thin event to the raw event data store;
comparing a time of creation of the third thin event with a time of creation of the first thin event; and
responsive to determining that the time of creation of the second thin event exceeds the threshold value from the time of creation of the first thin event, determining the second thin event as valid, wherein a valid event is added to the record associated with the thick event.

18. The computer system of claim 15, wherein the instructions when executed by the one or more computer processors, cause the one or more computer processors to further perform steps comprising:
storing additional attributes associated with an event in one or more database tables, wherein identifying one or more additional attributes associated with the thin event comprises joining the event attributes with the one or more database tables storing additional attributes.

19. The computer system of claim 15, wherein the raw event data store is a key-value store, wherein each event is stored using a key associated with a thick event, wherein monitoring the raw event data store comprises listening to changes to the key-value store.

20. The computer system of claim 15, wherein a thick event causes selection of a content item associated from a plurality of content items.
